(19) United States
(12) Patent Application Publication
(10) Pub. No.: US 2026/0261648 A1
(43) Pub. Date: Sep. 3, 2026

(54) CONTENT OUTPUT SYSTEM AND CONTENT OUTPUT CONTROL METHOD

(71) Applicant: HONDA MOTOR CO., LTD., Tokyo (JP)

(72) Inventor: Ayaka Nobuchi, Tokyo (JP)

(21) Appl. No.: 19/442,351

(22) Filed: Jan. 7, 2026

(30) Foreign Application Priority Data
Mar. 3, 2025 (JP) 2025-032624

(51) Int. Cl. H04N 17/00

(52) U.S. Cl. CPC H04N 17/004

(57) ABSTRACT

A content output system includes a plurality of content output sections and a control section configured to control the content output sections. The control section includes a load determination section, a setting section, and a priority decision section. The load determination section determines whether or not a processing load on the control section is a high load. The setting section performs content output settings for the respective content output sections. The content output settings are settings that are each related to an output of content. The priority decision sections decides priorities for performing the content output settings for the respective content output sections. In a case where the load determination section determines that the processing load on the control section is a high load, the setting section performs the content output settings based on the priorities decided by the priority decision section.

### INCORPORATION BY REFERENCE

The present application claims priority under 35 U.S.C. § 119 to Japanese Patent Application No. 2025-032624 filed on Mar. 3, 2025. The content of the application is incorporated herein by reference in its entirety.

### BACKGROUND OF THE INVENTION

### Field of the Invention

The present invention relates to a content output system and a content output control method.

### Description of the Related Art

A technology of performing settings related to the output of content has been conventionally known. For example, Japanese Patent Laid-Open No. 2005-142735 discloses a system including a wireless communication device and a reproduction device. The wireless communication device transmits an image of a camera to the reproduction device through a wireless network. The reproduction device outputs the image of the camera received from the wireless communication device. In the system disclosed in Japanese Patent Laid-Open No. 2005-142735, the greater the processing load on the wireless communication device, the lower the quality of the image output from the reproduction device.

In recent years, a system including a plurality of content output sections has been, however, studied. In this type of system, the output quality of content may also be decreased depending on the processing load on a control section that controls the content output sections. However, when the system including the plurality of content output sections concurrently performs settings (referred to as “content output settings” below) related to the outputs of pieces of content for all the content output sections, the convenience of the outputs of the pieces of content may be lost.

For example, it is assumed that a certain content output section is outputting content of high importance for a user and another content output section is outputting content of low importance for the user. In this example, when the content output settings are concurrently made for all the content output sections, the content of high importance for the user is also changed and the convenience thereof may be lost.

In addition, for example, it is assumed that a certain content output section is outputting content preferred by a user and another content output section is outputting content which is not preferred by the user. In this example, when the content output settings are concurrently made for all the content output sections, the content preferred by the user is also changed and the convenience thereof can be lost.

Accordingly, the present invention has been devised in view of the circumstances described above. An object of the present invention is to make it possible to restrain the output quality of content from being decreased because of a processing load and restrain the convenience of the output of the content from being lost.

### SUMMARY OF THE INVENTION

An aspect of the present invention is a content output system including: a plurality of content output sections; and a control section configured to control the content output sections. The control section includes a load determination section, a setting section, and a priority decision section. The load determination section is configured to determine whether or not a processing load on the control section is a high load. The setting section is configured to perform content output settings for the respective content output sections. The content output settings are settings that are each related to an output of content. The priority decision section is configured to decide priorities for performing the content output settings for the respective content output sections. In a case where the load determination section determines that the processing load on the control section is a high load, the setting section performs the content output settings based on the priorities decided by the priority decision section.

### Advantageous Effects of Invention

According to an aspect of the present invention, it is possible to restrain the output quality of content from being decreased because of a processing load and restrain the convenience of the output of the content from being lost.

### BRIEF DESCRIPTION OF THE DRAWINGS

FIG. 1 is a diagram illustrating a configuration of a vehicle;

FIG. 2 is a block diagram illustrating a configuration of a control ECU;

FIG. 3 is a flowchart illustrating an operation of the control ECU;

FIG. 4 is a flowchart illustrating an operation of the control ECU in a first frame rate changing process;

FIG. 5 is a diagram illustrating a specific example of the first frame rate changing process;

FIG. 6 is a flowchart illustrating an operation of the control ECU in a resolution changing process;

FIG. 7 is a diagram illustrating a specific example of the resolution changing process;

FIG. 8 is a flowchart illustrating an operation of the control ECU in a second frame rate changing process; and

FIG. 9 is a diagram illustrating a specific example of the second frame rate changing process.

### DETAILED DESCRIPTION OF THE INVENTION

### 1. Configuration of Vehicle

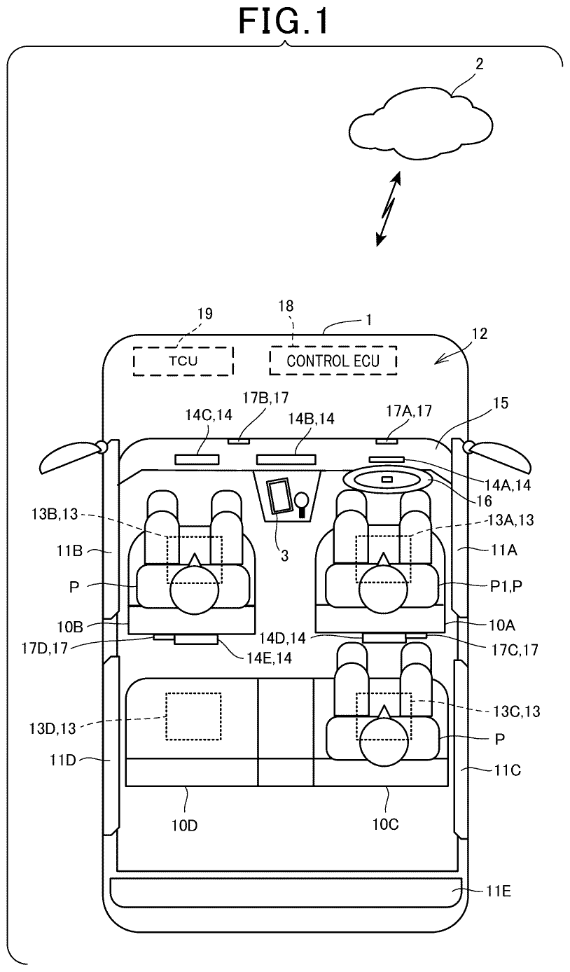

FIG. 1 is a diagram illustrating the configuration of a vehicle 1.

The vehicle 1 exemplified in FIG. 1 is a four-wheeled vehicle. The vehicle 1 includes a driver's seat 10A, a passenger seat 10B, a rear right seat 10C, and a rear left seat 10D. A driver P1 and the like are in the vehicle 1 in FIG. 1 as occupants P of the vehicle 1. The vehicle 1 in FIG. 1 illustrates a situation in which the driver P1 is sitting on the driver's seat 10A. In addition, the vehicle 1 in FIG. 1 illustrates a situation in which the occupant P other than the driver P1 is sitting on the passenger seat 10B. In addition, the vehicle 1 in FIG. 1 illustrates a situation in which the occupant P other than the driver P1 is sitting on the rear right seat 10C.

The vehicle 1 includes a right front door 11A, a left front door 11B, a right rear door 11C, a left rear door 11D, and a tailgate 11E. The right front door 11A, the left front door 11B, the right rear door 11C, and the left rear door 11D are opened to allow the vehicle cabin space of the vehicle 1 to be accessed. The tailgate 11E opens and closes the trunk of the vehicle 1.

The vehicle 1 includes a video output system 12. In other words, the video output system 12 is provided in the vehicle 1. The video output system 12 is a system that outputs video into the vehicle cabin.

The video output system 12 is an example of a “content output system”. The video is an example of “content”.

The video output system 12 includes seating sensors 13A, 13B, 13C, and 13D that each sense weight applied to the seat. The seating sensor 13A is provided to the driver's seat 10A, the seating sensor 13B is provided to the passenger seat 10B, the seating sensor 13C is provided to the rear right seat 10C, and the seating sensor 13D is provided to the rear left seat 10D.

The following description assigns a reference sign “13” and uses an expression “seating sensor 13” or “seating sensors 13” unless the seating sensors 13A, 13B, 13C, and 13D are distinguished.

The video output system 12 includes a driver's seat display 14A, a center display 14B, a passenger seat display 14C, a rear right seat display 14D, and a rear left seat display 14E.

The driver's seat display 14A, the center display 14B, the passenger seat display 14C, the rear right seat display 14D, and the rear left seat display 14E are examples of “content output sections”.

The following assigns a reference sign “14” and uses an expression “display 14” or “displays 14” unless the driver's seat display 14A, the center display 14B, the passenger seat display 14C, the rear right seat display 14D, and the rear left seat display 14E are distinguished.

The driver's seat display 14A is provided to a dashboard 15 on the back side of a steering wheel 16. The driver's seat display 14A displays the videos of the speed of the vehicle 1, the integrated traveled distance of the vehicle 1, the ambient temperature, the fuel efficiency information, and the like.

The center display 14B and the passenger seat display 14C are installed on the dashboard 15. The passenger seat display 14C is installed closer to the passenger seat 10B than the center display 14B.

The rear right seat display 14D is installed at a position visually recognized by the occupant P sitting on the rear right seat 10C. For example, the rear right seat display 14D is installed on the back of the driver's seat 10A or the like.

The rear left seat display 14E is installed at a position visually recognized by the occupant P sitting on the rear left seat 10D. For example, the rear left seat display 14E is installed on the back of the passenger seat 10B or the like.

The video output system 12 includes cameras 17A, 17B, 17C, and 17D that each capture an image of the inside of the vehicle cabin.

The image capturing range of the camera 17A is set to a range that makes it possible to capture an image of the occupant P sitting on the driver's seat 10A. If described in more detail, the image capturing range of the camera 17A is set to a range that makes it possible to capture an image of the head of the occupant P sitting on the driver's seat 10A.

The image capturing range of the camera 17B is set to a range that makes it possible to capture an image of the occupant P sitting on the passenger seat 10B. If described in more detail, the image capturing range of the camera 17B is set to a range that makes it possible to capture an image of the head of the occupant P sitting on the passenger seat 10B.

For example, the camera 17C is installed on the back of the driver's seat 10A and captures an image of the occupant P sitting on the rear right seat 10C. The image capturing range of the camera 17C is set to a range that makes it possible to capture an image of the occupant P sitting on the rear right seat 10C. If described in more detail, the image capturing range of the camera 17C is set to a range that makes it possible to capture an image of the head of the occupant P sitting on the rear right seat 10C.

For example, the camera 17D is installed on the back of the passenger seat 10B and captures an image of the occupant P sitting on the rear left seat 10D. The image capturing range of the camera 17D is set to a range that makes it possible to capture an image of the occupant P sitting on the rear left seat 10D. If described in more detail, the image capturing range of the camera 17D is set to a range that makes it possible to capture an image of the head of the occupant P sitting on the rear left seat 10D.

The following assigns a reference sign “17” and uses an expression “camera 17” or “cameras 17” unless the cameras 17A, 17B, 17C, and 17D are distinguished.

It is to be noted that the video output system may include one camera. In this case, for example, the one camera is installed near a center mirror and is set to have an image capturing range within which an image of the whole of the inside of the vehicle is captured.

The video output system 12 includes a control ECU (Electronic Control Unit) 18. The control ECU 18 is a control device that controls the displays 14 and the like. The control ECU 18 includes a tuner 181 and receives the broadcast waves of radio broadcasting, television broadcasting, and the like. In addition, the control ECU 18 receives data from Internet 2 through a TCU (Telematics Control Unit) 19. In addition, the control ECU 18 receives data from a portable terminal 3 carried into the vehicle 1.

The control ECU 18 corresponds to a “control section”.

The vehicle 1 includes the TCU 19. The TCU 19 is connected to the Internet 2.

### 2. Configuration of Control ECU

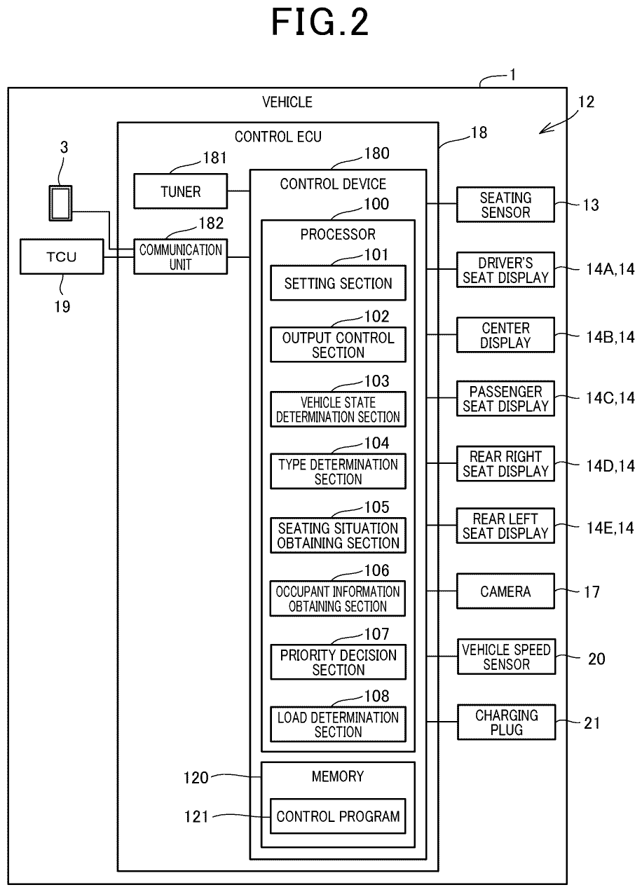

FIG. 2 is a block diagram illustrating the configuration of the control ECU 18.

The control ECU 18 includes a control device 180, the tuner 181, and a communication unit 182.

Before the control device 180 is described, the tuner 181 and the communication unit 182 will be described.

The tuner 181 operates under the control of the control device 180. The tuner 181 receives broadcast waves through an unillustrated antenna. In addition, the tuner 181 converts the received broadcast waves into video data. The tuner 181 then outputs the converted video data to the control device 180.

The communication unit 182 includes communication hardware such as a communication circuit and a connector. The communication unit 182 is a transmitter and a receiver and receives video data from the TCU 19 and outputs the received video data to the control device 180 under the control of the control device 180.

In addition, the communication unit 182 receives video data from the portable terminal 3 and outputs the received video data to the control device 180 under the control of the control device 180.

The control device 180 includes a processor 100 such as a CPU (Central Processing Unit) and an MPU (Micro Processor Unit), a memory 120, and an interface circuit for connecting other devices and sensors. The tuner 181, the communication unit 182, the seating sensors 13, the displays 14, the cameras 17, a vehicle speed sensor 20, and a charging plug 21 are connected to the control device 180.

The vehicle speed sensor 20 is a sensor that senses the speed of the vehicle 1.

The charging plug 21 is a plug to which a charging connector for charging the vehicle 1 is connected. In a case where the charging connector is connected, the charging plug 21 outputs, to the control device 180, a connection signal indicating that the charging connector is connected. In a case where the charging connector is not connected, the charging plug 21 outputs no connection signal to the control device 180.

The memory 120 is a storage device that stores a program and data. The memory 120 stores a control program 121, data to be processed by the processor 100, and the like. The memory 120 includes a non-volatile storage region. In addition, the memory 120 may include a volatile storage region and may configure the work area of the processor 100. The memory 120 includes, for example, a ROM (Read Only Memory) or a RAM (Random Access Memory).

The control program 121 is a program that causes the processor 100 to function as functional sections described below.

The processor 100 functions as a setting section 101, an output control section 102, a vehicle state determination section 103, a type determination section 104, a seating situation obtaining section 105, an occupant information obtaining section 106, a priority decision section 107, and a load determination section 108 by executing the control program 121.

### 2-1. Setting Section

The setting section 101 performs settings (referred to as “video output settings” below) related to the output of video. The setting section 101 is capable of performing video output settings for the respective displays 14. Elements to be set in the video output settings are a frame rate and resolution. The setting section 101 sets a frame rate in the video output settings. The setting section 101 sets resolution in the video output settings in some cases.

The video output settings are an example of “content output settings”. The frame rate is an example of each of “first targets”. The resolution is an example of each of “second targets”.

### 2-2. Output Control Section

The output control section 102 outputs video data to each of the displays 14 to cause the display 14 to output video.

The output control section 102 generates video to be output by the driver's seat display 14A based on a sensed value of the vehicle speed sensor 20 or the like and causes the driver's seat display 14A to output the generated video.

In a case where a request to output the video of the broadcast waves is made by each of the displays 14 other than the driver's seat display 14A, the output control section 102 causes the display 14 that made the output request to output the video indicated by the video data received from the tuner 181.

In a case where a request to output video received from the Internet 2 is made by each of the displays 14 other than the driver's seat display 14A, the output control section 102 receives the video data from the Internet 2 through the communication unit 182 and the TCU 19. The output control section 102 then causes the display 14 that made the output request to output the video indicated by the received video data.

In a case where a request to output video received from the portable terminal 3 is made by each of the displays 14 other than the driver's seat display 14A, the output control section 102 receives the video data from the portable terminal 3 through the communication unit 182. The output control section 102 then causes the display 14 that made the output request to output the video indicated by the received video data.

In a case where the setting section 101 sets a frame rate for the certain display 14, the output control section 102 causes the display 14 having the set frame rate to output video.

In addition, in a case where the setting section 101 sets resolution for the certain display 14, the output control section 102 causes the display 14 having the set resolution to output video.

### 2-3. Vehicle State Determination Section

The vehicle state determination section 103 determines the state of the vehicle 1.

The vehicle state determination section 103 determines whether or not the vehicle 1 is traveling. For example, in a case where a sensed value of the vehicle speed sensor 20 indicates a speed of zero, the vehicle state determination section 103 determines that the vehicle 1 is not traveling. In a case where a sensed value of the vehicle speed sensor 20 indicates speed having a value other than zero, the vehicle state determination section 103 determines that the vehicle 1 is traveling.

It is to be noted that a determination as to whether or not the vehicle 1 is traveling is not limited to a determination based on the vehicle speed sensor 20. It may be determined whether or not the vehicle 1 is traveling on the basis that an accessory power supply is turned on or off or based on the position of the shift lever or the like.

The vehicle state determination section 103 determines whether or not the vehicle 1 is being charged. For example, in a case where a connection signal is output from the charging plug 21, the vehicle state determination section 103 determines that the vehicle 1 is being charged. In a case where no connection signal is output from the charging plug 21, the vehicle state determination section 103 determines that the vehicle 1 is not being charged.

### 2-4. Type Determination Section

The type determination section 104 determines the types of videos to be output by the displays 14 for the respective displays 14. The type determination section 104 according to the present embodiment determines the type of video to be output by each of the displays 14 as any of a first type, a second type, and a third type.

Video of the first type is video that is essential for the driver P1 when the driver P1 drives. Examples thereof include video including the speed of the vehicle 1 and the like.

Video of the second type is video that assists the driver P1 in driving. Examples thereof include navigation video.

Video of the third type is video other than the video of the first type and the video of the second type. Examples thereof include entertainment video such as a movie.

The type determination section 104 determines the type of video to be output by the driver's seat display 14A as the first type. This is because the video of the speed of the vehicle 1 and the like is output to the driver's seat display 14A as described above.

The type determination section 104 determines the type of video to be output by the center display 14B as the second type or the third type.

For example, in a case where video to be output by the center display 14B is navigation video, the type determination section 104 determines the type of the video to be output by the center display 14B as the second type.

In addition, for example, in a case where video to be output by the center display 14B is entertainment video, the type determination section 104 determines the type of the video to be output by the center display 14B as the third type.

It is to be noted that the type determination section 104 obtains information about the type of video to be output by the center display 14B from the output control section 102 to determine the type of the video to be output by the center display 14B.

The type determination section 104 determines each of the types of videos to be output by the passenger seat display 14C, the rear right seat display 14D, and the rear left seat display 14E as the third type. This is because each of the videos to be output by these displays 14 is typically entertainment video.

### 2-5. Seating Situation Obtaining Section

The seating situation obtaining section 105 obtains the seating situation of the occupants P in the vehicle 1 based on results of sensing by the seating sensors 13.

For example, it is assumed that the seating sensors 13 which are each sensing a weight of a predetermined value or more include only the seating sensor 13A. It is to be noted that this predetermined value is a value for determining whether or not the seat is occupied by someone. In the case of this example, the seating situation obtaining section 105 senses that the occupant P is sitting on only the driver's seat 10A as a seating situation.

In addition, for example, it is assumed that the seating sensors 13 which are each sensing a weight of a predetermined value or more include only the seating sensors 13A, 13B, and 13C. In the case of this example, the seating situation obtaining section 105 obtains the occupants P sitting on the driver's seat 10A, the passenger seat 10B, and the rear right seat 10C as a seating situation.

### 2-6. Occupant Information Obtaining Section

The occupant information obtaining section 106 obtains occupant information for each of the occupants P sitting on the seats. In the present embodiment, the occupant information obtaining section 106 obtains information as to whether or not the occupant P is sleeping as occupant information.

The occupant information obtaining section 106 senses each of the occupants P from a captured image obtained by the camera 17 by pattern matching or the like. In a case where it is possible to sense the occupant P from the captured image, the occupant information obtaining section 106 senses the eyes from the captured image. In a case where the sensed eyes remain closed for a predetermined time or more, the occupant information obtaining section 106 obtains the occupant P corresponding to the camera 17 being sleeping. Meanwhile, in a case where it is possible to sense the occupant P from the captured image obtained by the camera 17, the occupant information obtaining section 106 senses the eyes from the captured image. In a case where the sensed eyes do not remain closed for the predetermined time or more, the occupant information obtaining section 106 obtains the occupant P corresponding to the camera 17 not being sleeping. It is to be noted that data (data of the shapes of the eyes or data of the colors of the eyes) necessary to sense the occupant P or the eyes in the captured image is stored in the memory 120.

### 2-7. Priority Decision Section

The priority decision section 107 decides priorities for the setting section 101 to perform video output settings for the respective displays 14.

In the present embodiment, the priorities are each described as “N-th”. The numeral N represents an integer of 1 or more. In the present embodiment, as the numeral N of “N-th” is smaller, the priority for performing video output settings is higher. For example, the “first” priority is the highest priority for performing video output settings. In addition, for example, the “second” priority is a lower priority for performing video output settings than the “first” priority.

Hereinafter, a plurality of decision techniques of the priority decision section 107 will be described.

### 2-7-1. First Decision Technique

In a first decision technique, the priority decision section 107 decides the priorities based on the state of the vehicle 1 determined by the vehicle state determination section 103.

In a case where the vehicle state determination section 103 determines that the vehicle 1 is traveling, the priority decision section 107 decides the priorities as follows.

That is, the priority decision section 107 decides that the passenger seat display 14C, the rear right seat display 14D, and the rear left seat display 14E are equally ranked at the “first” priority, decides that the center display 14B is ranked at the “second” priority, and decides that the driver's seat display 14A is ranked at the “third” priority.

In a case where the vehicle state determination section 103 determines that the vehicle 1 is not traveling and the vehicle state determination section 103 determines that the vehicle 1 is being charged, the priority decision section 107 decides the priorities as follows.

That is, the priority decision section 107 decides that the driver's seat display 14A is ranked at the “first” priority, decides that the center display 14B is ranked at the “second” priority, and decides that the passenger seat display 14C, the rear right seat display 14D, and the rear left seat display 14E are equally ranked at the “third” priority.

In a case where the vehicle state determination section 103 determines that the vehicle 1 is not traveling and the vehicle state determination section 103 determines that the vehicle 1 is not being charged, the priority decision section 107 decides the priorities as follows.

That is, the priority decision section 107 decides that the passenger seat display 14C, the rear right seat display 14D, and the rear left seat display 14E are equally ranked at the “first” priority, decides that the center display 14B is ranked at the “second” priority, and decides that the driver's seat display 14A is ranked at the “third” priority.

### 2-7-2. Second Decision Technique

In a second decision technique, the priority decision section 107 decides the priorities based on the types of videos determined by the type determination section 104.

The priority decision section 107 ranks the display 14 that outputs video of the third type at a higher priority than the display 14 that outputs video of the first type or the second type. In addition, the priority decision section 107 ranks the display 14 that outputs video of the second type at a higher priority than the display 14 that outputs video of the first type.

For example, it is assumed that the center display 14B is outputting video of the second type and all the displays 14 are concurrently outputting videos.

As described above, the type determination section 104 determines the type of video to be output by the driver's seat display 14A as the first type. In addition, the type determination section 104 determines the type of video to be output by the center display 14B as the second type or the third type. In addition, the type determination section 104 determines each of the types of videos to be output by the passenger seat display 14C, the rear right seat display 14D, and the rear left seat display 14E as the third type.

Thus, in this example, the priority decision section 107 decides that the passenger seat display 14C, the rear right seat display 14D, and the rear left seat display 14E are equally ranked at the “first” priority, decides that the center display 14B is ranked at the “second” priority, and decides that the driver's seat display 14A is ranked at the “third” priority.

In addition, for example, it is assumed that the center display 14B is outputting video of the third type and all the displays 14 are concurrently outputting videos.

In this example, the priority decision section 107 decides that the center display 14B, the passenger seat display 14C, the rear right seat display 14D, and the rear left seat display 14E are equally ranked at the “first” priority and decides that the driver's seat display 14A is ranked at the “second” priority.

It is to be noted that the second decision technique may take into consideration a result of a determination by the vehicle state determination section 103.

For example, in a case where the vehicle state determination section 103 determines that the vehicle 1 is not traveling and the vehicle state determination section 103 determines that the vehicle 1 is being charged, the priority decision section 107 decides the priorities as follows.

That is, the priority decision section 107 ranks the display 14 that outputs video of the first type at a higher priority than the display 14 that outputs video of the second type or the third type. In addition, the priority decision section 107 ranks the display 14 that outputs video of the second type at a higher priority than the display 14 that outputs video of the third type.

For example, it is assumed that the center display 14B is outputting video of the third type and all the displays 14 are concurrently outputting videos. In addition, it is assumed that the vehicle state determination section 103 determines that the vehicle 1 is not traveling and determines that the vehicle 1 is being charged.

In this example, the priority decision section 107 decides that the driver's seat display 14A is ranked at the “first” priority and decides that the center display 14B, the passenger seat display 14C, the rear right seat display 14D, and the rear left seat display 14E are equally ranked at the “second” priority.

### 2-7-3. Third Decision Technique

In the third decision technique, the priority decision section 107 decides the priorities based on a seating situation obtained by the seating situation obtaining section 105.

The priority decision section 107 ranks the display 14 corresponding to a seat on which the occupants P are not each sitting at a higher priority than the display 14 corresponding to the seat on which the occupants P are each sitting.

It is to be noted that the display 14 corresponding to a seat specifically means the following.

The displays 14 corresponding to the driver's seat 10A are the driver's seat display 14A and the center display 14B.

The display 14 corresponding to the passenger seat 10B is the passenger seat display 14C.

The display 14 corresponding to the rear right seat 10C is the rear right seat display 14D.

The display 14 corresponding to the rear left seat 10D is the rear left seat display 14E.

Here, a plurality of examples is shown for the third decision technique.

For example, it is assumed that the occupants P are sitting on the driver's seat 10A, the passenger seat 10B, and the rear right seat 10C and the occupant P is not sitting on the rear left seat 10D.

In the case of this example, the priority decision section 107 decides that the rear left seat display 14E is ranked at a higher priority than the other displays 14.

In addition, for example, it is assumed that the occupants P are sitting on the driver's seat 10A and the rear right seat 10C and the occupants P are not sitting on the passenger seat 10B and the rear left seat 10D.

In the case of this example, the priority decision section 107 decides that the passenger seat display 14C and the rear left seat display 14E are ranked at a higher priority than the other displays 14.

It is to be noted that the third decision technique may take into consideration a result of a determination by the type determination section 104.

For example, it is assumed that the occupants P are sitting on the driver's seat 10A, the passenger seat 10B, and the rear right seat 10C and the occupant P is not sitting on the rear left seat 10D. In addition, for example, it is assumed that the driver's seat display 14A is outputting video of the first type, the center display 14B is outputting video of the second type, and the passenger seat display 14C, the rear right seat display 14D, and the rear left seat display 14E are each outputting video of the third type.

In the case of this example, the priority decision section 107 decides that the rear left seat display 14E corresponding to the vacant rear left seat 10D is ranked at the “first” priority. In addition, in the case of this example, the priority decision section 107 decides that the passenger seat display 14C and the rear right seat display 14D which are each outputting video of the third type are ranked at the “second” priority. In addition, in the case of this example, the priority decision section 107 decides that the center display 14B is ranked at the “third” priority. In addition, in the case of this example, the priority decision section 107 decides that the driver's seat display 14A is ranked at the “fourth” priority.

### 2-7-4. Fourth Decision Technique

In the fourth decision technique, the priority decision section 107 decides the priorities based on occupant information obtained by the occupant information obtaining section 106.

The priority decision section 107 decides that the display 14 corresponding to the sleeping occupant P is ranked at a higher priority than the display 14 corresponding to the occupant P who is not sleeping.

It is to be noted that the display 14 corresponding to the occupant P specifically means the following.

The displays 14 corresponding to the driver P1 are the driver's seat display 14A and the center display 14B.

The display 14 corresponding to the occupant P sitting on the passenger seat 10B is the passenger seat display 14C.

The display 14 corresponding to the occupant P sitting on the rear right seat 10C is the rear right seat display 14D.

The display 14 corresponding to the occupant P sitting on the rear left seat 10D is the rear left seat display 14E.

Here, a plurality of examples is shown for the fourth decision technique.

For example, it is assumed that the respective occupants P are sitting on the driver's seat 10A, the passenger seat 10B, the rear right seat 10C, and the rear left seat 10D and the occupant P on the passenger seat 10B is sleeping.

In the case of this example, the priority decision section 107 decides that the passenger seat display 14C is ranked at a higher priority than the displays 14 other than the passenger seat display 14C.

In addition, for example, it is assumed that the respective occupants P are sitting on the driver's seat 10A, the passenger seat 10B, the rear right seat 10C, and the rear left seat 10D and the occupants P on the passenger seat 10B and the rear left seat 10D are sleeping.

In the case of this example, the priority decision section 107 decides that the passenger seat display 14C and the rear left seat display 14E are ranked at a higher priority than the displays 14 other than these two displays 14.

It is to be noted that the fourth decision technique may take into consideration a result of a determination by the type determination section 104.

For example, it is assumed that the occupants P are sitting on the driver's seat 10A, the passenger seat 10B, the rear right seat 10C, and the rear left seat 10D and the occupant P on the rear left seat 10D is sleeping. In addition, for example, it is assumed that the driver's seat display 14A is outputting video of the first type, the center display 14B is outputting video of the second type, and the passenger seat display 14C, the rear right seat display 14D, and the rear left seat display 14E are each outputting video of the third type.

In the case of this example, the priority decision section 107 decides that the rear left seat display 14E corresponding to the sleeping occupant P is ranked at the “first” priority. In addition, in the case of this example, the priority decision section 107 decides that the passenger seat display 14C and the rear right seat display 14D which are each outputting video of the third type are ranked at the “second” priority. In addition, in the case of this example, the priority decision section 107 decides that the center display 14B is ranked at the “third” priority. In addition, in the case of this example, the priority decision section 107 decides that the driver's seat display 14A is ranked at the “fourth” priority.

As described above, the plurality of decision techniques of the priority decision section 107 has been described. The priority decision section 107 may decide the priorities using any of the first decision technique to the fourth decision technique or may decide the priorities by combining any techniques from the first decision technique to the fourth decision technique.

### 2-8. Load Determination Section

The load determination section 108 determines whether or not the processing load on the control ECU 18 is a high load. For example, the load determination section 108 calculates the activity ratio of the processor 100 using an existing technology as the processing load on the control ECU 18. In a case where the calculated activity ratio of the processor 100 is greater than or equal to a predetermined value (e.g., 85%), the load determination section 108 determines that the processing load on the control ECU 18 is a high load. In a case where the calculated activity ratio of the processor 100 is less than the predetermined value, the load determination section 108 determines that the processing load on the control ECU 18 is not a high load. It is to be noted that a determination about the processing load by the load determination section 108 is not limited to a determination based on the activity ratio of the processor 100. For example, the determination may be made based on MIPS (Million Instruction Per Second), the condition of communication of the Internet 2, the condition of communication with the portable terminal 3, or the like.

### 3. Operation of Control ECU

Next, an operation of the control ECU 18 will be described.

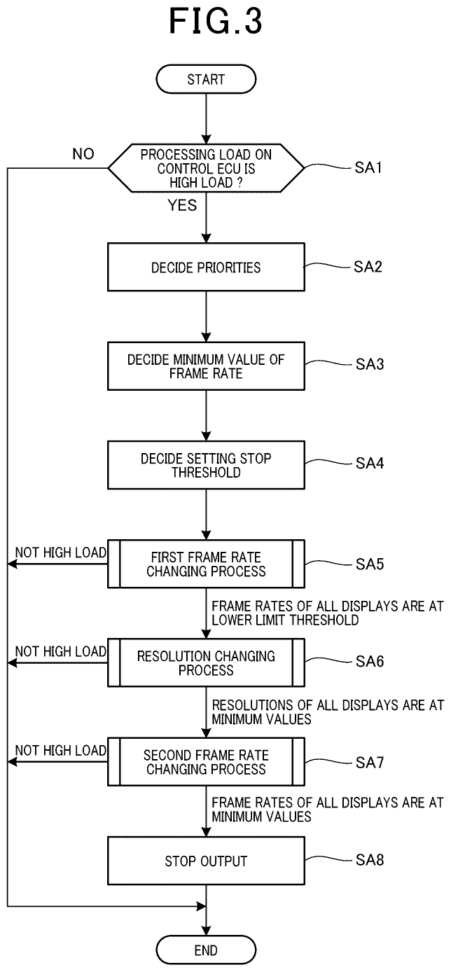

FIG. 3 is a flowchart illustrating an operation of the control ECU 18.

The load determination section 108 determines whether or not the processing load on the control ECU 18 is a high load (step SA1). In a case where the load determination section 108 determines that the processing load on the control ECU is not a high load (step SA1: NO), the control ECU 18 brings the process of FIG. 3 to an end.

In contrast, in a case where the load determination section 108 determines that the processing load on the control ECU 18 is a high load (step SA1: YES), the priority decision section 107 decides the priorities (step SA2).

Subsequently, the setting section 101 decides the minimum values of the frame rates for the respective displays 14 based on the priorities decided in step SA2 (step SA3). It is to be noted that the minimum values of the frame rates decided in step SA3 are values which are each lower than a frame rate at which no video output settings are made.

Step SA3 will be described in detail.

The setting section 101 decides that the frame rate for the display 14 lower in priority has a higher minimum value.

For example, it is assumed that the rear left seat display 14E and the rear right seat display 14D are decided to be ranked at the “first” priority, the passenger seat display 14C is decided to be ranked at the “second” priority, the center display 14B is decided to be ranked at the “third” priority, and the driver's seat display 14A is decided to be ranked at the “fourth” priority.

In the case of this example, the setting section 101 decides that the minimum values of the frame rates of the rear left seat display 14E and the rear right seat display 14D are “A fps (flames per second)”.

In addition, in the case of this example, the setting section 101 decides that the minimum value of the frame rate of the passenger seat display 14C is “B fps”. It is to be noted that “B fps” is higher than “A fps”.

In addition, in the case of this example, the setting section 101 decides that the minimum value of the frame rate of the center display 14B is “C fps”. It is to be noted that “C fps” is higher than “B fps”.

In addition, in the case of this example, the setting section 101 decides that the minimum value of the frame rate of the driver's seat display 14A is “D fps”. It is to be noted that “D fps” is higher than “C fps”.

It is to be noted that the minimum values of the frame rates corresponding to the priorities may be decided in advance for the priorities.

Subsequently, the setting section 101 sets the minimum value having the highest value among the minimum values of the frame rates decided in step SA3 as a setting stop threshold (step SA4). This setting stop threshold is a threshold that stops a frame rate from being set in a first frame rate changing process described below.

Step SA4 will be described in detail.

For example, it is assumed that the setting section 101 sets the minimum values of the frame rates of the respective displays 14 to the minimum values exemplified in the detailed description of step SA3. In the case of this example, the setting section 101 sets “D fps” as the lower limit threshold in step SA4.

Subsequently, the control ECU 18 performs the first frame rate changing process (step SA5).

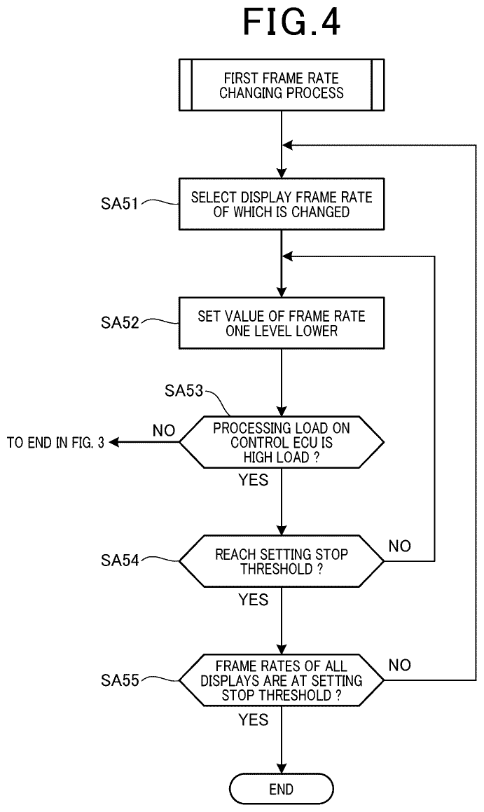

FIG. 4 is a flowchart illustrating an operation of the control ECU 18 in the first frame rate changing process.

The setting section 101 decides the display 14 the frame rate of which is changed based on the priorities decided in step SA2 (step SA51).

Step SA51 will be described in detail.

In step SA51 performed for the first time after the first frame rate changing process is started, the setting section 101 decides that the display 14 at the highest priority is the display 14 the frame rate of which is changed.

In step SA51 performed for the second or subsequent time after the first frame rate changing process is started, the setting section 101 decides that the display 14 at the second highest priority after the display 14 decided in last step SA51 is the display 14 the frame rate of which is changed.

Subsequently, the setting section 101 sets the value of the frame rate of the display 14 decided in step SA51 one level lower than the current value (step SA52). It is to be noted that setting the value of the frame rate one level lower means decreasing the frame rate by a predetermined value. This predetermined value may be a value defined in advance or may be a value calculated based on the processing load on the control ECU 18. In step SA52, the setting section 101 does not set the frame rate lower than the setting stop threshold set in step SA4.

Subsequently, the load determination section 108 determines whether or not the processing load on the control ECU 18 is a high load (step SA53).

In a case where the load determination section 108 determines that the processing load on the control ECU 18 is not a high load (step SA53: NO), the control ECU 18 brings the first frame rate changing process to an end and also bring the process illustrated in FIG. 3 to an end.

In contrast, in a case where the load determination section 108 determines that the processing load on the control ECU 18 is a high load (step SA53: YES), the setting section 101 determines whether or not the frame rate reaches the setting stop threshold in the settings in step SA52 (step SA54).

In a case where the setting section 101 determines that the frame rate does not reach the setting stop threshold in the settings in step SA52 (step SA54: NO), the setting section 101 returns the process to step SA52 and sets the frame rate of the display 14 decided in step SA51 further one level lower.

In contrast, in a case where the setting section 101 determines that the frame rate reaches the setting stop threshold in the settings in step SA52 (step SA54: YES), the setting section 101 determines whether or not the frame rates of all the displays 14 are at the setting stop threshold (step SA55).

In a case where the setting section 101 determines that the frame rates of all the displays 14 are not at the setting stop threshold (step SA55: NO), the setting section 101 returns the process to step SA51 and performs the processes of step SA51 and the subsequent steps again.

In contrast, in a case where the setting section 101 determines that the frame rates of all the displays 14 are at the setting stop threshold (step SA55: YES), the control ECU 18 brings the first frame rate changing process to an end.

In this way, in the first frame rate changing process, the values of the frame rates are decreased toward the setting stop threshold from the displays 14 at the highest priority downward.

If described in more detail, the setting section 101 decreases the value of the frame rate of the certain display 14. If the processing load on the control ECU 18 is a high load, the setting section 101 further decreases the value of the frame rate of the certain display 14. The setting section 101 gradually decreases the frame rate of the certain display 14 until the processing load on the control ECU 18 is no longer a high load or the value of the frame rate reaches the setting stop threshold. The setting section 101 then decreases the frame rate of the display 14 at the second highest priority after the certain display 14 in a case where the processing load on the control ECU 18 is a high load even after the value of the frame rate of the certain display 14 is decreased to the setting stop threshold.

Additionally, in a case where the plurality of displays 14 is ranked at the same priority, the setting section 101 may concurrently decrease the frame rates for the displays 14 at the same priority or may select the one display 14 from the displays 14 at the same priority and decrease the frame rate thereof.

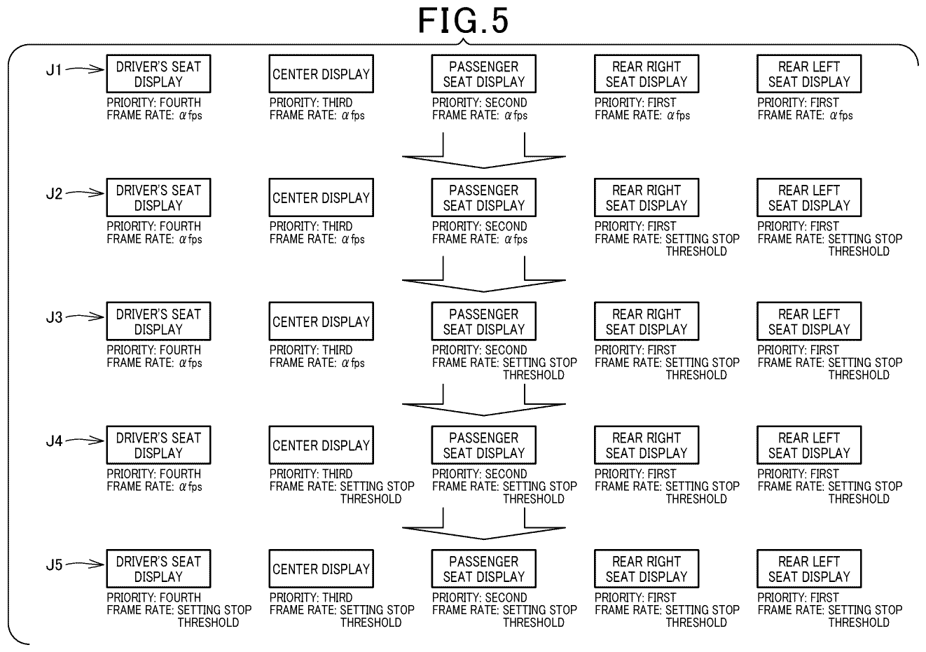

Here, the first frame rate changing process will be specifically described with reference to FIG. 5.

FIG. 5 is a diagram illustrating a specific example of the first frame rate changing process.

In FIG. 5, a status J1 shows that the first frame rate changing process has not yet been executed. In the status J1, the priority decision section 107 decides the priorities for the respective displays 14. When the first frame rate changing process is started in the status J1, the setting section 101 decreases the frame rate of the rear right seat display 14D or the rear left seat display 14E.

In FIG. 5, a status J2 shows a case where the frame rates of the rear right seat display 14D and the rear left seat display 14E are decreased to the setting stop threshold in the first frame rate changing process. Additionally, in a case where the frame rate of the rear right seat display 14D or the rear left seat display 14E is changed and the processing load on the control ECU 18 is thus no longer a high load, the control ECU 18 does not set the status J2 as the status of the respective displays 14 and brings the first frame rate changing process and the process of FIG. 3 to an end.

In the status J2, the first frame rate changing process is continued. When the status of the respective displays 14 is the status J2, the setting section 101 then decreases the frame rate of the passenger seat display 14C.

In FIG. 5, a status J3 shows a case where the frame rates of the passenger seat display 14C, the rear right seat display 14D, and the rear left seat display 14E are decreased to the setting stop threshold in the first frame rate changing process. Additionally, in a case where the frame rate of the passenger seat display 14C is changed and the processing load on the control ECU 18 is thus no longer a high load, the control ECU 18 does not set the status J3 as the status of the respective displays 14 and brings the first frame rate changing process and the process of FIG. 3 to an end.

In the status J3, the first frame rate changing process is continued. When the status of the respective displays 14 is the status J3, the setting section 101 then decreases the frame rate of the center display 14B.

In FIG. 5, a status J4 shows a case where the frame rates of the center display 14B, the passenger seat display 14C, the rear right seat display 14D, and the rear left seat display 14E are decreased to the setting stop threshold in the first frame rate changing process. Additionally, in a case where the frame rate of the center display 14B is changed and the processing load on the control ECU 18 is thus no longer a high load, the control ECU 18 does not set the status J4 as the status of the respective displays 14 and brings the first frame rate changing process and the process of FIG. 3 to an end.

In the status J4, the first frame rate changing process is continued. When the status of the respective displays 14 is the status J4, the setting section 101 then decreases the frame rate of the driver's seat display 14A.

In FIG. 5, a status J5 shows a case where the frame rates of all the displays 14 are decreased to the setting stop threshold in the first frame rate changing process. Additionally, in a case where the frame rate of the driver's seat display 14A is changed and the processing load on the control ECU 18 is thus no longer a high load, the control ECU 18 does not set the status J5 as the status of the respective displays 14 and brings the first frame rate changing process and the process of FIG. 3 to an end.

In the status J5, the first frame rate changing process is brought to an end. When the status of the respective displays 14 is the status J5, the control ECU 18 executes step SA6 in FIG. 3.

FIG. 3 will be described again. In a case where the frame rates of all the displays 14 reach the setting stop threshold in the first frame rate changing process, the setting section 101 executes a resolution changing process (step SA6).

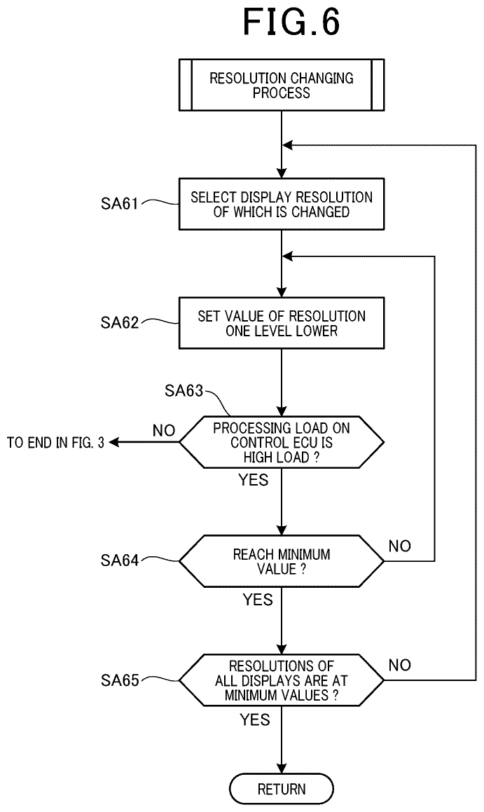

FIG. 6 is a flowchart illustrating an operation of the control ECU 18 in the resolution changing process.

The setting section 101 decides the display 14 the resolution of which is changed based on the priorities decided in step SA2 (step SA61).

Step SA61 will be described in detail.

In step SA61 performed for the first time after the resolution changing process is started, the setting section 101 decides that the display 14 at the highest priority is the display 14 the resolution of which is changed.

In step SA61 performed for the second or subsequent time after the resolution changing process is started, the setting section 101 decides that the display 14 at the second highest priority after the display 14 decided in last step SA61 is the display 14 the resolution of which is changed.

Subsequently, the setting section 101 sets the value of the resolution of the display 14 decided in step SA61 one level lower than the current value (step SA62). It is to be noted that setting the value of the resolution one level lower means decreasing the resolution by a predetermined value. This predetermined value may be a value defined in advance or may be a value calculated based on the processing load on the control ECU 18.

Subsequently, the load determination section 108 determines whether or not the processing load on the control ECU 18 is a high load (step SA63).

In a case where the load determination section 108 determines that the processing load on the control ECU 18 is not a high load (step SA63: NO), the control ECU 18 brings the resolution changing process to an end and also bring the process illustrated in FIG. 3 to an end.

In contrast, in a case where the load determination section 108 determines that the processing load on the control ECU 18 is a high load (step SA63: YES), the setting section 101 determines whether or not the resolution reaches the minimum value in the settings in step SA62 (step SA64). It is to be noted that the minimum values compared in step SA64 may be values different depending on the priorities or may be the same value regardless of the priorities.

In a case where the setting section 101 determines that the resolution does not reach the minimum value in the settings in step SA62 (step SA64: NO), the setting section 101 returns the process to step SA62 and sets the resolution of the display 14 decided in step SA61 further one level lower.

In contrast, in a case where the setting section 101 determines that the resolution reaches the minimum value in the settings in step SA62 (step SA64: YES), the setting section 101 determines whether or not the resolutions of all the displays 14 are at the minimum values (step SA65).

In a case where the setting section 101 determines that the resolutions of all the displays 14 are not at the minimum values (step SA65: NO), the setting section 101 returns the process to step SA61 and performs the processes of step SA61 and the subsequent steps again.

In contrast, in a case where the setting section 101 determines that the resolutions of all the displays 14 are at the minimum values (step SA65: YES), the control ECU 18 brings the resolution changing process to an end.

In this way, in the resolution changing process, the values of the resolutions are decreased toward the minimum values from the displays 14 at the highest priority downward.

If described in more detail, the setting section 101 decreases the value of the resolution of the certain display 14. If the processing load on the control ECU 18 is a high load, the setting section 101 further decreases the value of the resolution of the certain display 14. The setting section 101 gradually decreases the resolution of the certain display 14 until the processing load on the control ECU 18 is no longer a high load or the resolution reaches the minimum value. The setting section 101 then decreases the resolution of the display 14 at the second highest priority after the certain display 14 in a case where the processing load on the control ECU 18 is a high load even after the value of the resolution of the certain display 14 is decreased to the minimum value.

Additionally, in a case where the plurality of displays 14 is ranked at the same priority, the setting section 101 may concurrently perform the resolution changing processes on the displays 14 at the same priority or may select the one display 14 from the displays 14 at the same priority and perform the resolution changing process thereon.

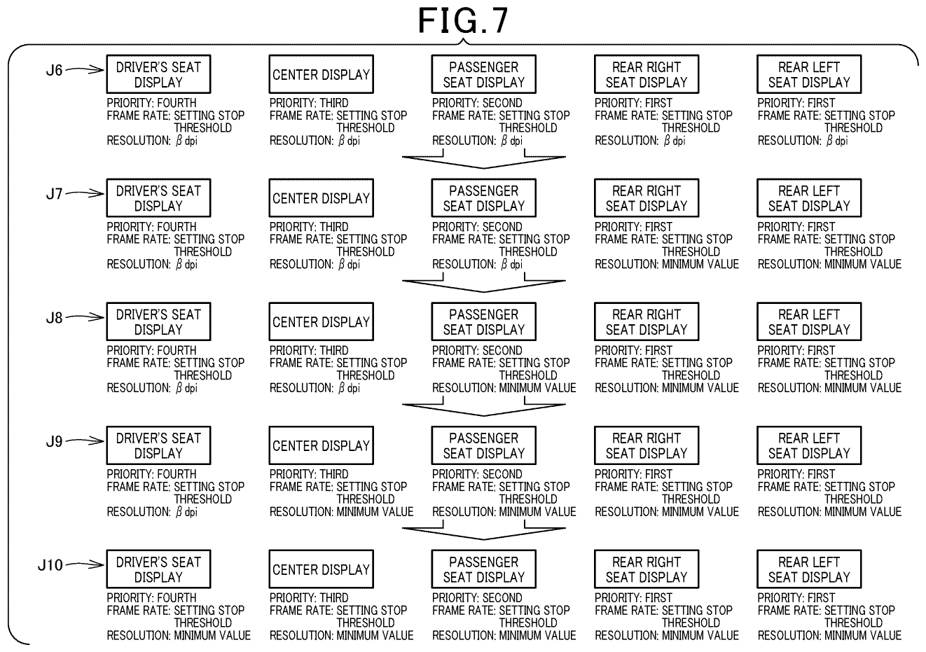

Here, the resolution changing process will be specifically described with reference to FIG. 7.

FIG. 7 is a diagram illustrating a specific example of the resolution changing process.

In FIG. 7, a status J6 shows that the resolution changing process has not yet been executed. In the status J6, the frame rate of each of the displays 14 is set at the setting stop threshold. When the resolution changing process is started in the status J6, the setting section 101 decreases the resolution of the rear right seat display 14D or the rear left seat display 14E.

In FIG. 7, a status J7 shows a case where the resolutions of the rear right seat display 14D and the rear left seat display 14E are decreased to the minimum values in the resolution changing process. Additionally, in a case where the resolution of the rear right seat display 14D or the rear left seat display 14E is changed and the processing load on the control ECU 18 is thus no longer a high load, the control ECU 18 does not set the status J7 as the status of the respective displays 14 and brings the resolution changing process and the process of FIG. 3 to an end.

In the status J7, the resolution changing process is continued. When the status of the respective displays 14 is the status J7, the setting section 101 then decreases the resolution of the passenger seat display 14C.

In FIG. 7, a status J8 shows a case where the resolutions of the passenger seat display 14C, the rear right seat display 14D, and the rear left seat display 14E are decreased to the minimum values in the resolution changing process. Additionally, in a case where the resolution of the passenger seat display 14C is changed and the processing load on the control ECU 18 is thus no longer a high load, the control ECU 18 does not set the status J8 as the status of the respective displays 14 and brings the resolution changing process and the process of FIG. 3 to an end.

In the status J8, the resolution changing process is continued. When the status of the respective displays 14 is the status J8, the setting section 101 then decreases the resolution of the center display 14B.

In FIG. 7, a status J9 shows a case where the resolutions of the center display 14B, the passenger seat display 14C, the rear right seat display 14D, and the rear left seat display 14E are decreased to the minimum values in the resolution changing process. Additionally, in a case where the resolution of the center display 14B is changed and the processing load on the control ECU 18 is thus no longer a high load, the control ECU 18 does not set the status J9 as the status of the respective displays 14 and brings the resolution changing process and the process of FIG. 3 to an end.

In the status J9, the resolution changing process is continued. When the status of the respective displays 14 is the status J9, the setting section 101 then decreases the resolution of the driver's seat display 14A.

In FIG. 7, a status J10 shows a case where the resolutions of all the displays 14 are decreased to the minimum values in the resolution changing process. Additionally, in a case where the resolution of the driver's seat display 14A is changed and the processing load on the control ECU 18 is thus no longer a high load, the control ECU 18 does not set the status J10 as the status of the respective displays 14 and brings the resolution changing process and the process of FIG. 3 to an end.

In the status J10, the resolution changing process is brought to an end. When the status of the respective displays 14 is the status J10, the control ECU 18 executes step SA7 in FIG. 3.

FIG. 3 will be described again. In a case where the resolutions of all the displays 14 reach the minimum values in the resolution changing process, the setting section 101 executes a second frame rate changing process (step SA7).

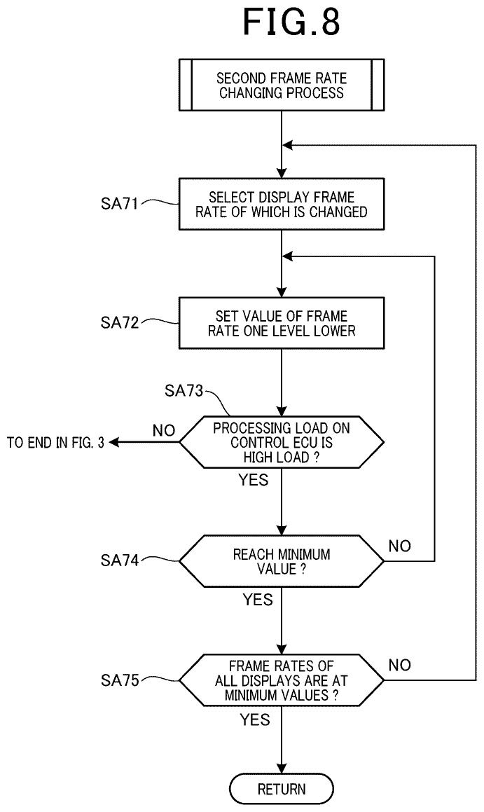

FIG. 8 is a flowchart illustrating an operation of the control ECU 18 in the second frame rate changing process.

The setting section 101 decides the display 14 the frame rate of which is changed from the displays 14 the frame rates of which do not reach the minimum values decided in step SA3 (step SA71).

When the setting section 101 decides the display 14 in step SA71, the setting section 101 sets the frame rate of the decided display 14 one level lower than the current frame rate (step SA72).

Subsequently, the load determination section 108 determines whether or not the processing load on the control ECU 18 is a high load (step SA73).

In a case where the load determination section 108 determines that the processing load on the control ECU 18 is not a high load (step SA73: NO), the control ECU 18 brings the resolution changing process to an end and also bring the process illustrated in FIG. 3 to an end.

In contrast, in a case where the load determination section 108 determines that the processing load on the control ECU 18 is a high load (step SA73: YES), the setting section 101 determines whether or not the frame rate reaches the minimum value decided in step SA3 in the settings in step SA72 (step SA74). It is to be noted that the minimum values compared in step SA74 are the minimum values corresponding to the displays 14 the frame rates of which are set in step SA72.

In a case where the setting section 101 determines that the frame rate does not reach the minimum value (step SA74: NO), the setting section 101 returns the process to step SA72 and sets the frame rate of the display 14 decided in step SA71 further one level lower.

In contrast, in a case where the setting section 101 determines that the frame rate reaches the minimum value (step SA74: YES), the setting section 101 determines whether or not the frame rates of all the displays 14 are at the minimum values (step SA75).

In a case where the setting section 101 determines that the frame rates of all the displays 14 are not at the minimum values (step SA75: NO), the setting section 101 returns the process to step SA71 and performs the processes of step SA71 and the subsequent steps again.

In contrast, in a case where the setting section 101 determines that the frame rates of all the displays 14 are at the minimum values (step SA75: YES), the control ECU 18 brings the second frame rate changing process to an end.

In this way, the values of the frame rates are decreased toward the minimum values in a predetermined order (e.g., priorities decided by the priority decision section 107) for the displays 14 the values of the frame rates of which do not reach the minimum values in the second frame rate changing process. If described in more detail, the setting section 101 decreases the value of the frame rate of the certain display 14. If the processing load on the control ECU 18 is a high load, the setting section 101 further decreases the value of the frame rate of the certain display 14. The setting section 101 gradually decreases the frame rate of the certain display 14 until the processing load on the control ECU 18 is no longer a high load or the value of the frame rate reaches the minimum value. In a case where the processing load on the control ECU 18 is a high load even after the setting section 101 decreases the value of the frame rate of the certain display 14 to the minimum value, the setting section 101 then decreases the value of the frame rate of the other display 14 toward the minimum value.

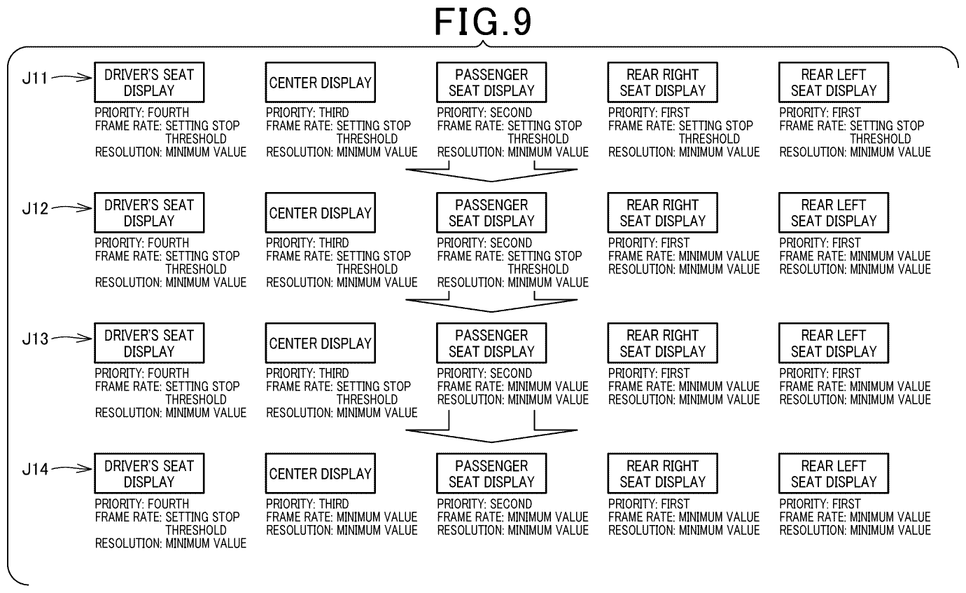

Here, the second frame rate changing process will be specifically described with reference to FIG. 9.

FIG. 9 is a diagram illustrating a specific example of the second frame rate changing process.

In FIG. 9, a status J11 shows that the second frame rate changing process has not yet been executed. In the status J11, the frame rate of each of the displays 14 is set at the setting stop threshold and the resolution of each of the displays 14 is set at the minimum value. When the second frame rate changing process is started in the status J11, the setting section 101 decreases the frame rate of the rear right seat display 14D or the rear left seat display 14E.

In FIG. 9, a status J12 shows a case where the frame rates of the rear right seat display 14D and the rear left seat display 14E are decreased to the minimum values in the second frame rate changing process. Additionally, in a case where the frame rate of the rear right seat display 14D or the rear left seat display 14E is changed and the processing load on the control ECU 18 is thus no longer a high load, the control ECU 18 does not set the status J12 as the status of the respective displays 14 and brings the second frame rate changing process and the process of FIG. 3 to an end.

In the status J12, the second frame rate changing process is continued. When the status of the respective displays 14 is the status J12, the setting section 101 decreases the frame rate of the passenger seat display 14C.

In FIG. 9, a status J13 shows a case where the frame rates of the passenger seat display 14C, the rear right seat display 14D, and the rear left seat display 14E are decreased to the minimum values in the second frame rate changing process. Additionally, in a case where the frame rate of the passenger seat display 14C is changed and the processing load on the control ECU 18 is thus no longer a high load, the control ECU 18 does not set the status J13 as the status of the respective displays 14 and brings the second frame rate changing process and the process of FIG. 3 to an end.

In the status J13, the second frame rate changing process is continued. When the status of the respective displays 14 is the status J13, the setting section 101 decreases the frame rate of the center display 14B.

In FIG. 9, a status J14 shows a case where the frame rates of the center display 14B, the passenger seat display 14C, the rear right seat display 14D, and the rear left seat display 14E are decreased to the minimum values in the second frame rate changing process. Additionally, in a case where the frame rate of the center display 14B is changed and the processing load on the control ECU 18 is thus no longer a high load, the control ECU 18 does not set the status J14 as the status of the respective displays 14 and brings the second frame rate changing process and the process of FIG. 3 to an end.

In the status J14, the second frame rate changing process is brought to an end. When the status of the respective displays 14 is the status J14, the control ECU 18 executes step SA8 in FIG. 3.

Here, the frame rate is not changed for the driver's seat display 14A because of the following reason. That is, this is because the setting stop threshold is the minimum value for the driver's seat display 14A.

FIG. 3 will be described again. In a case where the frame rates of all the displays 14 reach the minimum values in the second frame rate changing process, the output control section 102 stops each of the displays 14 from outputting video (step SA8). Additionally, in a case where sound is output by an unillustrated speaker, the output control section 102 does not have to stop the sound output.

In step SA8, the output control section 102 may stop all the displays 14 that each output video of the third type from each outputting the video or may stop all the displays 14 other than the driver's seat display 14A from each outputting video.

### 4. Other Embodiments

The embodiment described above shows merely an aspect. It is possible to optionally modify and apply the embodiment.

The embodiment described above adopts a configuration in which video output settings are made for all the displays 14. In another embodiment, the displays 14 for which video output settings are made may be fixed and the displays 14 for which video output settings are not made may be set depending on the priorities. For example, in the other embodiment, video output settings do not have to be made for the driver's seat display 14A.

The embodiment described above adopts a configuration in which the occupant information obtaining section 106 obtains information as to whether or not the occupant P is sleeping as occupant information. In another embodiment, the occupant information obtaining section 106 may obtain each of the line-of-sight directions of the occupants P as occupant information. In the other embodiment, the priority decision section 107 may then decide the priorities based on the line-of-sight directions of the occupants P.

This other embodiment will be described.

The occupant information obtaining section 106 senses, for the respective occupants P, the eyes of the occupants P from captured images of the cameras 17 as in the embodiment described above. The occupant information obtaining section 106 then obtains, for each of the occupants P, the direction that the sensed eyes face as the direction of the line of sight of the occupant P.

The priority decision section 107 decides that the display 14 which is not visually recognized by the occupant P is ranked at a higher priority than the display 14 which is visually recognized by the occupant P based on the line-of-sight direction of the occupant P obtained by the occupant information obtaining section 106.

The embodiment described above adopts a configuration in which the occupant information obtaining section 106 obtains information as to whether or not the occupant P is sleeping as occupant information. In another embodiment, the occupant information obtaining section 106 may obtain human information as occupant information. It is to be noted that the human information is information indicating at least whether or not the occupant P is an infant or a child. In the other embodiment, the priority decision section 107 may then decide the priorities based on the human information.

This other embodiment will be described.

In a case where it is possible to sense the occupant P from a captured image obtained by the camera 17, the occupant information obtaining section 106 determines whether the occupant P appearing in the captured image is an infant or a child using a technology such as pattern matching and obtains human information.

The priority decision section 107 decides that the display 14 corresponding to the seat on which the infant or the child is sitting is ranked at a higher priority than the display 14 corresponding to a seat on which the infant or the child is not sitting based on the human information obtained by the occupant information obtaining section 106.

In the embodiment described above, “video” is exemplified as the “content”. That is, in the embodiment described above, the video output system 12 is exemplified as the “content output system”. The “content” is not, however, limited to video alone. The “content” may be sound or the combination of video and sound.

For example, in a case where the “content output system” is a system that outputs sound, the “content output section” is a speaker. Additionally, in this case, a “first target” and a “second target” may be targets related to the output quality of sound such as an SN ratio, a dynamic range, and noise cancellation.

In addition, for example, in a case where the “content output system” is a system that outputs sound and video, the “content output section” is the combination of the display 14 and a speaker. Additionally, in this case, a “first target” and a “second target” may be targets related to the output qualities of video and sound such as a frame rate, resolution, an SN ratio, a dynamic range, and noise cancellation.

In the embodiment described above, the different displays 14 are each exemplified as the “content output section”. In another embodiment, in a case where one display screen concurrently outputs a plurality of videos, a region of the one display screen in which one video is output may be used as the “content output section”.

In the embodiment described above, the configuration in which the “content output sections” are provided to the vehicle 1 is exemplified, but the place in which the “content output sections” are each provided is not limited to the vehicle 1. The place in which the “content output sections” are each provided may be a system that is applied to an institution in which a plurality of speakers or monitors is installed or may be a system that is applied to a mobile object other than the vehicle 1.

In the embodiment described above, the case where all the displays 14 are the “content output sections” is exemplified, but the displays 14 other than the driver's seat display 14A may be the “content output sections” or the displays 14 other than the driver's seat display 14A and the center display 14B may be the “content output sections”. In addition, the number of “content output sections” mounted on the vehicle 1 may be four or less or six or more.

The processor 100 may include a plurality of processors or may include a single processor. The processor 100 may be hardware programmed to implement the functional sections described above. In this case, the processor 100 includes, for example, an ASIC (Application Specific Integrated Circuit) or an FPGA (Field Programmable Gate Array).

In addition, the configuration of the video output system 12 illustrated in FIG. 2 is an example and a specific implementation form thereof is not limited in particular. That is, hardware individually corresponding to each of the sections does not necessarily have to be implemented. Needless to say, it is also possible to adopt a configuration in which the function of each section is achieved by one processor executing a program. In addition, in the embodiment described above, some of the functions achieved by software may be achieved by hardware. Alternatively, some of the functions achieved by hardware may be achieved by software.

In addition, the step units of the operations illustrated in FIGS. 3, 4, 6, and 7 result from division depending on the main processing content. The present invention is not limited by the way of division depending on processing units or the names of the processing units. Depending on the processing content, the operations may be each divided in still more step units. In addition, the operations may be each divided such that one step unit includes still more processes. In addition, the order of the steps may be changed as appropriate within the range that does not impair the gist of the present invention.

In addition, in a case where the content output control method by the processor 100 described above is implemented using the processor 100, it is also possible to configure a program to be executed by the processor 100 as a recording medium or a transmission medium that transmits this program. That is, it is also possible to implement the control program 121 with the control program 121 recorded in a portable information recording medium. The information recording medium includes a magnetic recording medium such as a hard disk, an optical recording medium such as a CD, and a semiconductor storage device such as a USB (Universal Serial Bus) memory and an SSD (Solid State Drive). It is also possible to use other recording media.

### 5. Configurations Supported by Embodiments Above

The embodiments described above support the following configurations.

### Configuration 1

A content output system including: a plurality of content output sections; and a control section configured to control the content output sections, in which the control section includes a load determination section configured to determine whether or not a processing load on the control section is a high load, a setting section configured to perform content output settings for the respective content output sections, the content output settings being settings that are each related to an output of content, and a priority decision section configured to decide priorities for performing the content output settings for the respective content output sections, and in a case where the load determination section determines that the processing load on the control section is a high load, the setting section performs the content output settings based on the priorities decided by the priority decision section.

The content output system according to Configuration 1 performs the content output settings based on the priorities in a case where the processing load on the control section is a high load. This makes it possible to prevent a plurality of pieces of content from changing in output quality at the same timing. It is thus possible to restrain the output quality of content from being decreased because of a processing load and restrain the convenience of the output of the content from being lost.

### Configuration 2

The content output system according to Configuration 1, in which the content output system is provided in a vehicle, the content output system includes a vehicle state determination section configured to determine a state of the vehicle, and the priority decision section decides the priorities based on the state of the vehicle determined by the vehicle state determination section.

The content output system according to Configuration 2 makes it possible to decide the order for performing the content output settings in consideration of the state of the vehicle. This makes it possible to perform the content output settings for the content output sections in consideration of the content output situations compliant with the state of the vehicle. It is thus possible to restrain the convenience of the output of content in the vehicle from being lost.

### Configuration 3

The content output system according to Configuration 1 or 2, in which the content output system includes a type determination section configured to determine types of pieces of content to be output by the content output sections, and the priority decision section decides the priorities based on the types determined by the type determination section.

The content output system according to Configuration 3 makes it possible to decide the order for performing the content output settings in consideration of the types of the pieces of content. This makes it possible to perform the content output settings for the content output sections in consideration of the types of the pieces of content. It is thus possible to further restrain the convenience of the output of content from being lost.

### Configuration 4

The content output system according to any one of Configurations 1 to 3, in which the content output system is provided in a vehicle, the content output system includes a seating situation obtaining section configured to obtain a seating situation for respective seats included in the vehicle, and the priority decision section decides the priorities based on the seating situation obtained by the seating situation obtaining section.

The content output system according to Configuration 4 makes it possible to decide the order for performing the content output settings in consideration of the seating situation in the vehicle. This makes it possible to perform the content output settings for the content output sections in consideration of the content output situations compliant with the seating situation in the vehicle. It is thus possible to restrain the convenience of the output of content in the vehicle from being lost.

### Configuration 5

The content output system according to any one of Configurations 1 to 4, in which the content output system is provided in a vehicle, the content output system includes an occupant state obtaining section configured to obtain a state of an occupant of the vehicle, and the priority decision section decides the priorities based on the state of the occupant obtained by the occupant state obtaining section.

The content output system according to Configuration 5 makes it possible to decide the order for performing the content output settings in consideration of the occupant information about the vehicle. This makes it possible to perform the content output settings for the content output sections in consideration of the content output situations compliant with the occupant of the vehicle. It is thus possible to restrain the convenience of the output of content in the vehicle from being lost.

### Configuration 6

The content output system according to any one of Configurations 1 to 5, in which the content output settings include settings for first targets, and the setting section decides minimum values of the first targets for the respective content output sections based on the priorities, decides that a highest value of the decided minimum values of the first targets is a setting stop threshold for stopping the first targets from being set, and gradually decreases values of the first targets toward the setting stop threshold from the content output sections at the highest priority downward.

The content output system according to Configuration 6 gradually decreases the values of the first targets from the content output sections at the highest priority downward. This makes it possible to restrain a user of the content from feel strange about the content output settings.

### Configuration 7

The content output system according to Configuration 6, in which the content output settings include settings of second targets, and in a case where the load determination section determines that the processing load on the control section is a high load with the values of the first targets decreased to the setting stop threshold for all the content output sections, the setting section gradually decreases values of the second targets toward minimum values from the content output sections at the highest priority downward.

The content output system according to Configuration 7 attains effects similar to those of Configuration 1.

### Configuration 8

The content output system according to Configuration 7, in which, in a case where the load determination section determines that the processing load on the control section is a high load with the values of the second targets decreased to the minimum values for all the content output sections, the setting section gradually decreases the value of the first target toward the decided minimum value for the content output section where the value of the first target has not reached the decided minimum value.

In a case where the processing load is a high load even after the first targets and the second targets are decreased, the content output system according to Configuration 8 decreases the values of the first targets once again. This makes it possible to reduce the processing load on a control entity that controls the plurality of content output sections.

### Configuration 9

The content output system according to Configuration 8 or 9, in which pieces of content to be output by the content output sections each include video, each of the first targets is a frame rate, and each of the second targets is resolution.

In general, it is considered that decreasing a frame rate makes a change in content less strange when a frame rate and resolution are compared. The content output system according to Configuration 9 therefore makes it possible to further restrain a user of the content from feeling strange about the content output settings.

### Configuration 10

A content output control method, executed by a processor, including: determining whether or not a processing load on a control section is a high load, the control section being configured to control a plurality of content output sections; deciding priorities for performing content output settings for the respective content output sections in a case where the processing load on the control section is determined to be a high load, the content output settings being settings that are each related to an output of content; and performing the content output settings based on the decided priorities.

The content output control method according to Configuration 10 attains effects similar to those of the content output system according to Configuration 1.

### REFERENCE SIGNS LIST

1 vehicle
2 the Internet
3 portable terminal
10A driver's seat
10B passenger seat
10C rear right seat
10D rear left seat
11A right front door
11B left front door
11C right rear door
11D left rear door
11E tailgate
12 video output system (content output system)
13 seating sensor
13A to 13D seating sensor
14 display (content output section)
14A driver's seat display
14B center display
14C passenger seat display
14D rear right seat display
14E rear left seat display
15 dashboard
16 steering wheel
17 camera
17A to 17D camera
18 control ECU (control section)
19 TCU
20 vehicle speed sensor
21 charging plug
100 processor
101 setting section
102 output control section
103 vehicle state determination section
104 type determination section
105 seating situation obtaining section
106 occupant information obtaining section
107 priority decision section
108 load determination section
120 memory
121 control program
180 control device
181 tuner
182 communication unit
J1 to J14 status
P occupant
P1 driver

1. A content output system comprising:
a plurality of content output sections; and
a control section configured to control the content output sections, wherein
the control section includes
a load determination section configured to determine whether or not a processing load on the control section is a high load,
a setting section configured to perform content output settings for the respective content output sections, the content output settings being settings that are each related to an output of content, and
a priority decision section configured to decide priorities for performing the content output settings for the respective content output sections, and
in a case where the load determination section determines that the processing load on the control section is a high load, the setting section performs the content output settings based on the priorities decided by the priority decision section.

2. The content output system according to claim 1, wherein
the content output system is provided in a vehicle,
the content output system comprises a vehicle state determination section configured to determine a state of the vehicle, and
the priority decision section decides the priorities based on the state of the vehicle determined by the vehicle state determination section.

3. The content output system according to claim 1, wherein
the content output system comprises a type determination section configured to determine types of pieces of content to be output by the content output sections, and
the priority decision section decides the priorities based on the types determined by the type determination section.

4. The content output system according to claim 1, wherein
the content output system is provided in a vehicle,
the content output system comprises a seating situation obtaining section configured to obtain a seating situation for respective seats included in the vehicle, and
the priority decision section decides the priorities based on the seating situation obtained by the seating situation obtaining section.

5. The content output system according to claim 1, wherein
the content output system is provided in a vehicle,
the content output system comprises an occupant state obtaining section configured to obtain a state of an occupant of the vehicle, and
the priority decision section decides the priorities based on the state of the occupant obtained by the occupant state obtaining section.

6. The content output system according to claim 1, wherein
the content output settings include settings for first targets, and
the setting section
decides minimum values of the first targets for the respective content output sections based on the priorities,
decides that a highest value of the decided minimum values of the first targets is a setting stop threshold for stopping the first targets from being set, and
gradually decreases values of the first targets toward the setting stop threshold from the content output sections at the highest priority downward.

7. The content output system according to claim 6, wherein
the content output settings include settings of second targets, and
in a case where the load determination section determines that the processing load on the control section is a high load with the values of the first targets decreased to the setting stop threshold for all the content output sections, the setting section gradually decreases values of the second targets toward minimum values from the content output sections at the highest priority downward.

8. The content output system according to claim 7, wherein, in a case where the load determination section determines that the processing load on the control section is a high load with the values of the second targets decreased to the minimum values for all the content output sections, the setting section gradually decreases the value of the first target toward the decided minimum value for the content output section where the value of the first target has not reached the decided minimum value.

9. The content output system according to claim 8, wherein
pieces of content to be output by the content output sections each include video,
each of the first targets is a frame rate, and
each of the second targets is resolution.

10. A content output control method, executed by a processor, comprising:
determining whether or not a processing load on a control section is a high load, the control section being configured to control a plurality of content output sections;
deciding priorities for performing content output settings for the respective content output sections in a case where the processing load on the control section is determined to be a high load, the content output settings being settings that are each related to an output of content; and
performing the content output settings based on the decided priorities.
